(19) United States
(12) Patent Application Publication
(10) Pub. No.: US 2012/0092768 A1
(43) Pub. Date: Apr. 19, 2012

(54) LENS DRIVING DEVICE, AUTOFOCUS CAMERA, AND CAMERA-EQUIPPED MOBILE TERMINAL

(75) Inventors: Manabu Shiraki, Kanagawa (JP); Koji Toyama, Kanagawa (JP)

(73) Assignee: SHICOH CO., LTD., Kanagawa (JP)

(21) Appl. No.: 13/274,752

(22) Filed: Oct. 17, 2011

(30) Foreign Application Priority Data
Oct. 19, 2010 (JP) 2010-234282

(51) Int. Cl. G02B 27/64; G02B 7/09; H04N 5/232

(52) U.S. Cl. 359/557; 348/357; 359/814; 348/E05.045

(57) ABSTRACT

In a lens driving device of the present invention, each magnet is provide to face an outer circumferential face of a first coil, and face a second coil at a position at which the second coil is provided. A first spring member and a second spring member are configured by a plurality of six springs separated from each other, each coil wire end of the first coil and the two of the second coils being connected to a different spring, respectively, and when moving a lens support (5) in the optical axis direction, electric current is flowed through the first coil, and when moving the lens support in an X-Y direction that is orthogonal to the optical axis, a predetermined electric current is flowed through a predetermined one of the second coils.

This application is based on and claims the benefit of priority from Japanese Patent Application No. 2010-234282, filed on 19 Oct. 2010, the content of which is incorporated herein by reference.

### BACKGROUND OF THE INVENTION

1. Field of the Invention

The present invention relates to a lens driving device, an autofocus camera and a camera-equipped mobile terminal.

2. Related Art

Prior Art Document 1 (Japanese Unexamined Patent Application, Publication No. 2009-80217) discloses providing a first coil wound around a circumferential direction of a lens support, a magnet provided at a fixed member and disposed to face the first coil, a first spring member provided on one side (front side) of the lens support in an optical axis direction, and a second spring member provided on the other side (rear side) of the lens support in the optical axis direction, and moving the lens support in the optical axis direction by passing current through the first coil.

In the technology of Prior Art Document 1, it is disclosed that the second spring member is configured by two springs separated from each other, with one coil wire end of the first coil being connected to one spring, and another coil wire end of the first coil being connected to the other spring, and that the lens support is made to move in the optical axis direction by passing electric current through the first coil via the second spring member.

### SUMMARY OF THE INVENTION

On the other hand, the present inventors have developed a technique of performing image stabilization of the lens support by providing a first coil wound around the circumferential direction of the lens support as well as providing at least two second coils at 90 degree intervals in the circumferential direction of the lens support, causing the lens support to move in the optical axis direction by passing current through the first coil, and by causing the lens support to move in the X-Y direction by passing electrical current of a predetermined value through a predetermined coil among the two second coils.

However, in a case of providing two second coils to the lens support and passing current through each of the second coils, the other side (rear side) spring member, which is already being used for the first coil as a current path to the second coil, cannot be used. In this case, the one end and the other end of the coil wire of the second coil are considered to be drawn out from the lens driving device to be directly connected to an external power terminal or a control unit.

However, since the one end and the other end of the coil wire of the second coil are drawn out from the lens driving device to be connected to the external power terminal or a control unit, labor is required for drawing out each wire and for connection to the external power terminal or control unit, and there is concern over the wires drawn out from the coil becoming a hindrance and restricting the driving of the lens support.

Therefore, the present invention has an object of providing a lens driving device, an autofocus camera and a camera-equipped mobile terminal for which manufacture is easy, the concern over driving of the lens support being hindered is reduced, and both movement of the lens support in the optical axis direction and movement for image stabilization are possible.

In order to achieve this object, a lens driving device according to a first aspect of the invention includes: a lens support for supporting a lens in an inner circumference thereof; a fixed member provided at an outer circumferential side of the lens support; a fixed member provided at an outer circumferential side of the lens support; a first spring member provided at one side of the lens support in an optical axis direction and supporting the lens support to be freely movable by mounting one end thereof to the fixed member, and mounting another end thereof to the lens support; a second spring member provided at another side of the lens support in the optical axis direction and supporting the lens support to be freely movable by mounting one end thereof to the fixed member and mounting another end thereof to the lens support; a first coil wound in a circumferential direction around the outer circumference of the lens support; two second coils disposed with a 90 degree interval in the circumferential direction at the outer circumference of the lens support; and a magnet provided at the fixed member, and provided to face an outer circumferential face of the first coil, the magnet being opposite the second coil at a position at which the second coil is provided, in which the first spring member and the second spring member are configured by a plurality of springs separated from each other, collectively having a total of six springs, each coil wire end of the first coil and the two of the second coils being connected to a different spring to allow an electric current to flow from the spring to each of the coils, respectively, and when moving the lens support in the optical axis direction, electric current is flowed through the first coil, and when moving the lens support in an X-Y direction that is orthogonal to the optical axis, a predetermined electric current is flowed through a predetermined one of the second coils.

According to the first aspect of the invention, focus movement of the lens support (movement in the optical axis direction) is performed by moving the lens support in the optical axis direction by way of the thrust in the optical axis direction arising with the magnet from passing current through the first coil, and image stabilization is performed by moving the lens support in the X-Y direction by way of the thrust in the radial direction of the lens support arising with the magnet by passing a predetermined electrical current through either of the second coils. Focus movement and image stabilization movement of the lens support are thereby possible.

A total of six springs are provided to the one side coil member and the other side coil member, with the first coil having two coil wire ends and the two second coils having four coil wire ends; therefore, by connecting a total of six coil wire ends to respectively different springs, the coil wires of each coil can be arranged without drawing to outside of the lens driving device, whereby the configuration is simple and manufacture thereof is facilitated.

In addition, the coil wires can be prevented from obstructing the movement of the lens support due to not drawing the coil wire ends to outside of the lens driving device.

The lens support is supported at two locations in the optical axis direction by a coil member on one side and a coil member on the other side; therefore, the lens support can be stably supported.

In the first aspect of the invention, it is preferable for each second coil to include two coil portions connected in series, each coil portion being provided at even intervals along the outer circumference of the lens support, and one of the second coils disposing two coil portions at positions opposing each other.

It is thereby possible to raise the driving force in the X-Y direction without increasing the number of springs connecting the coil wire ends.

According to a second aspect of the invention, an autofocus camera includes the lens driving device as described in the first aspect, and an image sensor provided at an image forming side of the lens of the lens support.

According to the second aspect of the invention, an autofocus camera can be provided that exerts similar effects to the first aspect of the invention.

According to a third aspect of the invention, a camera-equipped mobile terminal includes the autofocus camera as described in the second aspect.

Mobile terminal refers to a portable telephone, personal digital assistant (PDA), notebook computer, and the like.

According to the third aspect of the invention, it is possible to provide a camera-equipped mobile terminal that exerts the functional effects of the second aspect of the invention.

### BRIEF DESCRIPTION OF THE DRAWINGS

FIG. 1 is a view showing a connection relationship between spring members and each coil used in a lens driving device according to an embodiment of the first invention, with (a) being a plan view showing a connection relationship between a front-side spring member and a coil, and (b) being a plan view showing a connection relationship between a rear-side spring member and coils;

FIG. 2 is an exploded perspective view of the lens driving device according to an embodiment of the first invention;

FIG. 3(a) is a horizontal sectional view of the lens driving device according to an embodiment of the first invention, and (b) is a view schematically showing operation of the B portion shown in (a);

FIG. 4 is a cross-sectional view along a line A-A shown in FIG. 6 of the lens driving device according to an embodiment of the first invention;

FIG. 5 is a block diagram showing a relationship between a coil member and driving portion of an autofocus camera according to the first embodiment;

FIG. 6 is a perspective view showing an external appearance of the lens driving device according to the first embodiment; and

FIG. 7 is a plan view showing a connection relationship between a first spring member, second spring member, and each coil according to a modified example of the present invention.

### DETAILED DESCRIPTION OF THE INVENTION

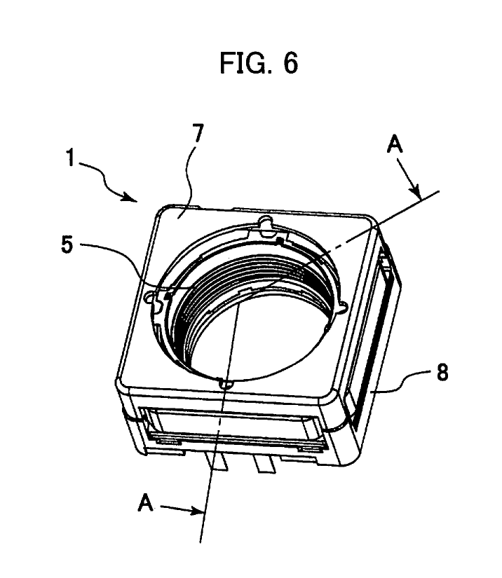

Below, an embodiment of the present invention will be explained in detail referring to the attached drawings. A lens driving device 1 according to the present embodiment shown in FIG. 6 is a lens driving device of an autofocus camera built into a mobile phone.

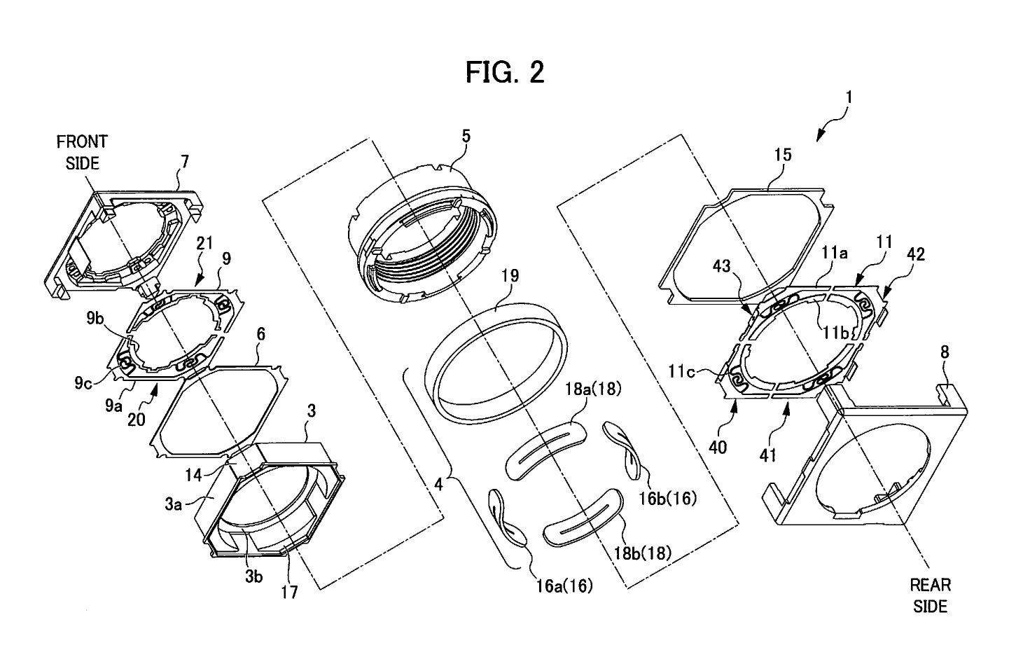

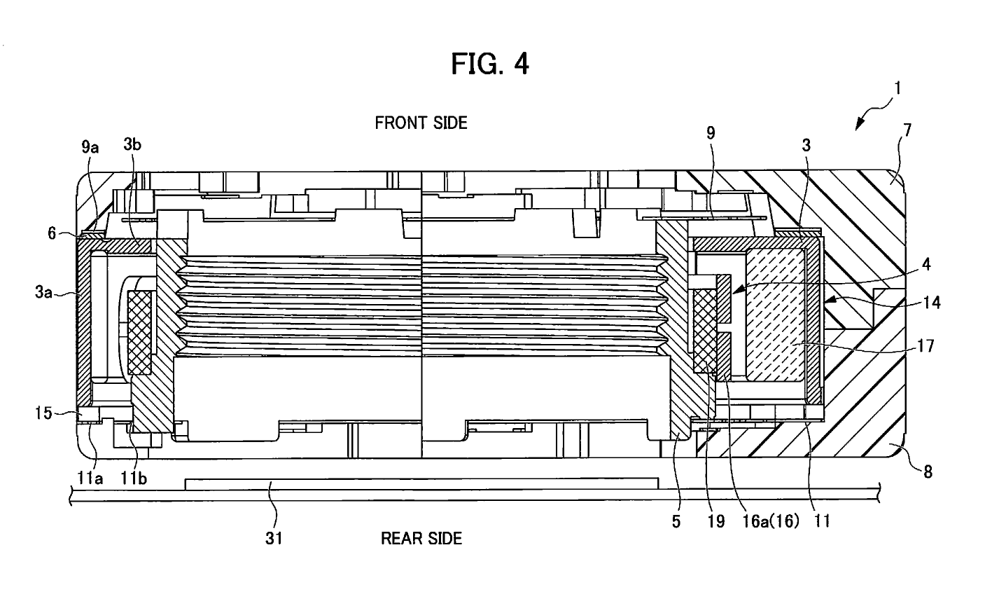

As shown in FIGS. 2 and 4, this lens driving device 1 is provided with a lens support 5 which supports a lens (not illustrated) at its inner circumference; a yoke 3 which arranges the lens support 5 so as to be freely moveable to its inner circumferential side; a frame 7 and front-side spring member (first spring member) 9 disposed at the optical axis direction of the yoke 3; and a base 8 and rear-side spring member (second spring member) 11 disposed at the rear side of the yoke 3, in which an insulating rear-side spacer 15 is disposed between the rear-side spring member 11 and the yoke 3. A coil 4 is fixed at the outer circumference of the lens support 5. It should be noted that an insulating front-side spacer 6 is disposed between the yoke 3 and the front-side spring member 9. In addition, the yoke 3, frame 7 and base 8 configure a fixed member in the present embodiment.

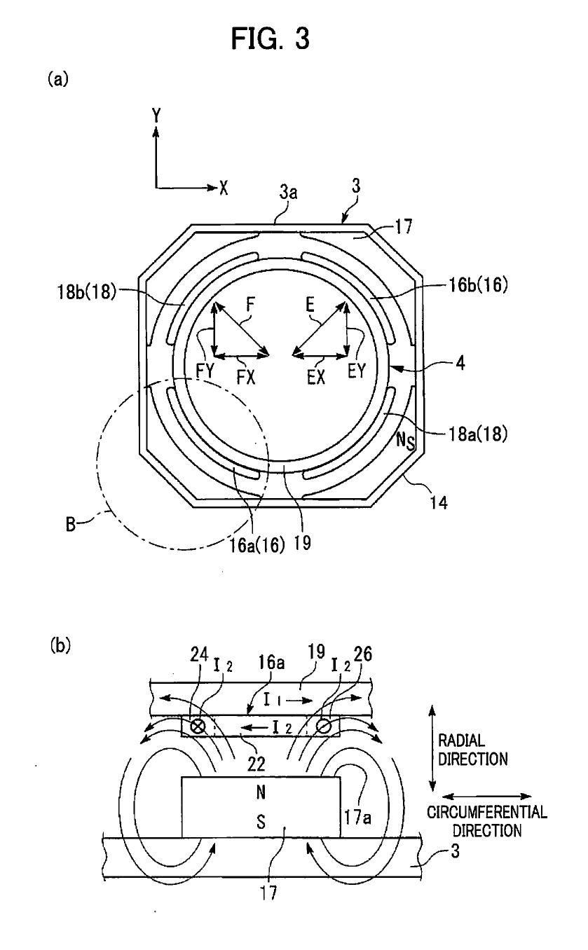

As shown in FIGS. 2 and 3(a), the yoke 3 has an outer circumference that is a rectangular shape in a plan view when seen from the front side, and has an inner circumference forming a ring shape of a circle in a plan view. Corner portions 14 of the square have a beveled shape. As shown in FIGS. 2 and 4, this yoke 3 is provided with an outer-circumferential side wall 3a and a radial wall extending from the front side of the outer-circumferential side wall 3a in the radial direction, whereby a cross-section having an L shape is formed by the outer-circumferential side wall 3a and the radial wall 3b.

As shown in FIGS. 2 to 4, magnets 17 are fixed at the inner-circumferential surface of the outer-circumferential side wall 3a in each corner portion 14 of the yoke 3. The magnets 17 are only provided at the corner portions 14.

As shown in FIG. 3(a), each magnet 17 is formed to have an approximately trapezoidal shape along the beveled corner portion 14 of the yoke 3 in a plane seen from the front side, and this inner circumferential side is formed to be arc shaped along the outer circumferential surface of the first coil 19 described later. In addition, the magnetic poles of the inner circumferential side and the outer circumferential side of the magnets 17 differ, for example, the inner circumferential side is the N pole and the outer circumferential side is the S pole. It should be noted that, although FIG. 3(a) is a horizontal section of the lens driving device 1, it is illustrated by omitting the lens support 5.

As shown in FIGS. 2 and 4, the lens support 5 has an approximately cylindrical shape, and the coil body 4 is fixed to the outer circumference thereof. The coil member 4 is configured from one first coil 19, and four second coil portions 16a, 16b, 18a and 18b. The four second coil portions 16a, 18a, 16b and 18b are arranged at even intervals (90 degree intervals) in the circumferential direction. Each of the second coil portions 16a, 16b, 18a and 18b have a toroidal form in a side view when seen from the outside in a radial direction of the lens support 5.

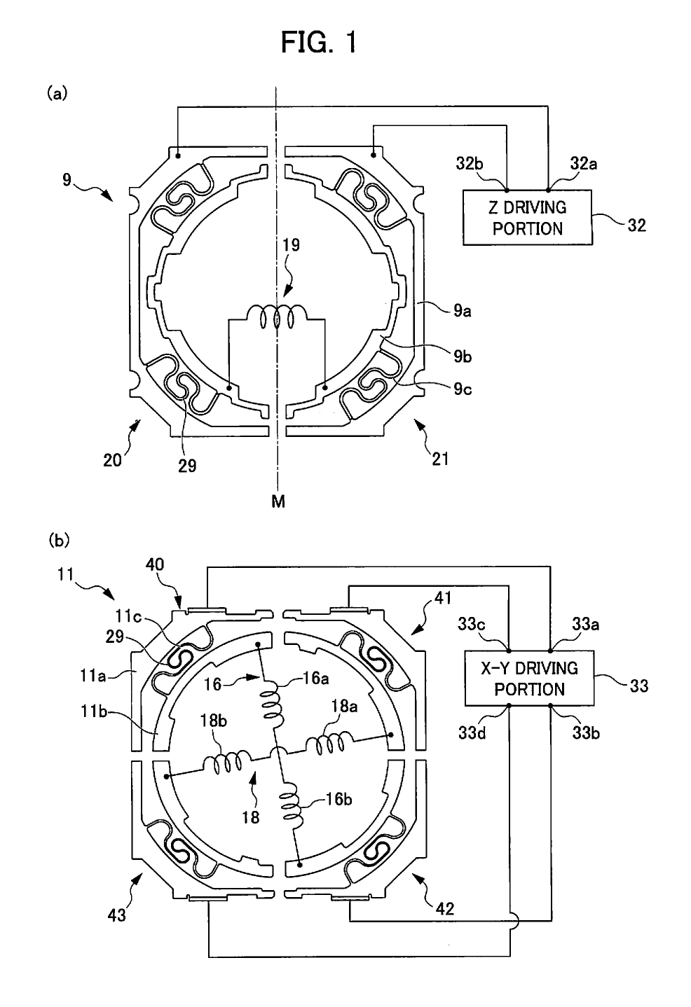

As shown in FIG. 1, two opposing (180 degree interval) second coil portions 16a and 16b are connected in series to configure one second coil 16, and two opposing (180 degree interval) second coils 18a and 18b are connected in series to configure the other second coil 18. In other words, the two second coils 16 and 18 are provided orthogonally in the coil member 4.

The first coil 19 forms a toroidal shape wound around the circumferential direction of the lens support 5.

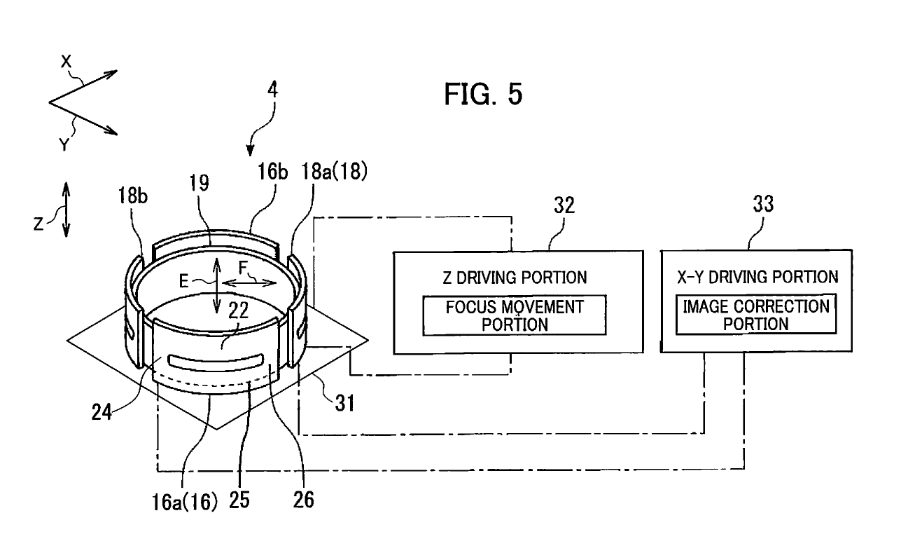

As shown in FIG. 5, each second coil portion 16a, 16b, 18a and 18b disposed to be overlapping at the outer circumferential face of the first coil 19, forming a square-ring shape in a side view seeing a side face of the lens support 5 from the outside, in which a front-side area portion 22, rear-side area portion 25, and left and right area portions 24 and 26 overlap the first coil 19.

As shown in FIG. 3, each of the magnets 17 is provided facing the second coil portions 16a, 16b, 18a and 18b, the magnets 17 facing the respective area portions 22, 25, 24 and 26 (refer to FIG. 5) of the respective second coil portions, the dimension of the magnets 17 in the circumferential direction being approximately the same size as the dimension of the respective second coil portions 16a, 16b, 18a and 18b in the circumferential direction, and the area of an inner circumferential face 17a of the magnet 17 being approximately the same area as the area of the opposing respective second coil portions 16a to 18b.

It should be noted that each of the magnets 17 is opposite the first coil 19 by interposing the opposing second coil portions 16a, 16b, 18a and 18b, respectively.

For the second coil portion 16a, as shown in FIG. 3(b), the directions of the magnetic flux leaving from the right (left) side portion of the inner circumferential face 17a of the magnet 17 have components in the radial direction inner direction and the circumferential direction right (left) direction, and curve further towards the right (left) side further away from the inner circumferential face 17a of the magnet 17. More specifically, the direction of the magnetic flux has components in the radial direction inner direction and in the right (left) direction with respect to the radial direction. In the same way, the magnetic flux leaving from the optical axis direction front side portion of the inner circumferential face 17a of the magnet 17 curve further towards the front direction side further away from the inner circumferential face 17a. Further, the direction of the magnetic flux leaving from the optical axis direction rear side portion of the inner circumferential face 17a of the magnet 17 has components in the radial direction inner direction and the optical axis direction rear direction, and curve further towards the rear direction side further away from the inner circumferential side face 17a.

For example, when an electric current I₁ flows in the counterclockwise direction when seen from the front direction side in the first coil 19, the flux linkage in the radial direction inner direction contributes to generating a thrust in the optical axis direction front direction by Fleming's left hand rule, and the lens support 5 moves in the optical axis direction front direction. When an electrical current I₂ flows in the counterclockwise direction when seen from the outside direction in the second coil 16a, the flux linkage components in the circumferential right direction of the second coil portion 16a contribute to generating a thrust in the radial direction inner direction at the right area portion 26 of the second coil portion 16a. In the same way, a thrust is also generated in the radial direction inner direction at the front-side area portion 22, rear-side area portion 25 and left area portion 24 of the second coil portion 16a. As a result, the lens support 5 moves in the radial direction inner direction. In the same way, a thrust is generated in the radial direction at the second coil portions 16b, 18a and 18b as well.

Moreover, for the second coil portions 16a and 16b configuring the one second coil 16, a thrust E acts in the radial direction of the lens support 5, as shown in FIG. 3(a), by the magnetic force of the components orthogonal, in the radial direction, to the second coil portions 16a and 16b among the magnetic flux of the magnets 17, and the electric current flowing through one of the second coil portions 16a, 16b, according to Fleming's left hand rule, and in the same way, for the second coil portions 18a, 18b configuring the other second coil 18, a thrust F acts in the radial direction of the lens support 5. The thrust E and the thrust F are orthogonal to each other. It should be noted that, when flowing electrical current, the second coil portions 16a and 16b configuring the one second coil 16 form a partnership such that the thrust E acts in the same direction. In the same way, the second coil portions 18a and 18b configuring the other second coil 18 also form a partnership.

As shown in FIG. 5, the first coil 19 is connected to a Z driving portion 32, the one second coil 16 and the other second coil 18 are connected to X-Y driving portions 33, respectively, and an electrical current of a predetermined value is passed through each driving portion 32 and 33. It should be noted that, in FIG. 5, dotted lines show the outward connecting line from the Z driving portion 32 to the first coil 19 and the outward connecting lines from the X-Y driving portions 33 to the second coils 16 and 18, respectively.

In the present embodiment, the second coil portions 16a and 16b configuring the one second coil 16 are connected in series, the second coil portions 18a and 18b configuring the other second coil 18 are connected in series, and are configured so as to drive in the direction of the thrust E with the one second coil 16 and in the direction of the thrust F with the other second coil 18.

For example, in the Z driving portion 32, in the case of moving the lens support 5 to a focus position (movement in the optical axis direction), an electric current Z flows in the first coil 19.

In the same way, in the case of image stabilization, in the X-Y driving portions 33, an electric current E flows in the one second coil 16 and moves the lens support in the E direction, and an electric current F flows in the other second coil 18 and moves the lens support 5 in the F direction. In this way, image stabilization is carried out by moving the lens support 5 in the E-F direction.

It should be noted that, in the FIGS. 3 and 5, the reference symbols Z, E and F indicate the magnitude and direction of the thrust arising based on the flowing electric current.

However, as shown in FIG. 3, in the present embodiment, the X direction is the direction of the sides of the square-shaped yoke 3 and the Y direction is another direction of the yoke 3, and concerning the thrusts E and F generated in the diagonal direction of the yoke 3, the sum of the X direction force components EX and FX acts as the thrust in the X direction, and the sum of the Y direction force components EY and FY acts as the thrust in the Y direction, and in the X-Y driving portion 33, control is carried out by making the sum of each of the force components EX+FX in the X direction equal to the X direction thrust and the sum of the each of the force components EY+FY in the Y direction equal to the Y direction thrust.

As shown in FIGS. 1(a) and 2, the front-side spring member 9 has a plate shape in its natural state before assembly, and is overall constituted of an outer circumferential side portion 9a forming a planar view rectangular toroid, an inner circumferential side portion 9b which has a planar view arc shape, and is disposed at the inner circumference of the outer circumferential side portion 9a, and four arm portions 9c linking the outer circumferential portion 9a and the inner circumferential portion 9b ; and can be freely deformed in the Z direction and in the X-Y direction.

The front-side spring member 9 is configured from the two springs of a front-side first spring 20 and a front-side second spring 21, and as shown in FIG. 1, the front-side first spring 20 and the front-side second spring 21 are made in a substantially line-symmetrical shape (arm portion 9c is nonsymmetrical) relative to a center line M dividing the front-side spring member 9.

One tip of the first coil 19 is connected to an inner circumferential side portion 9b of the front-side first spring 20, and the other tip of the first coil 19 is connected to the inner circumferential side portion 9b of the second spring 21. The outer circumferential side portion 9a of the front-side first spring 20 is connected to a plus side current terminal 32a of the Z driving portion 32, and the outer circumferential side portion 9a of the front-side second spring 21 is connected to a minus-side current terminal 32b of the Z driving portion 32.

It should be noted that, as shown in FIG. 4, the outer circumferential side portion 9a of the front-side spring member 9 is placed between the front-side spacer 6 disposed on the front side of the yoke 3 and the frame 7, and the inner circumferential side portion 9b is fixed to a front end of the lens support 5. The front-side spring member 9 presses the lens support 5 to the rear side by causing the outer circumferential side portion 9a to deform so as to be more to the rear side than the inner circumferential side portion 9b.

As shown in FIGS. 1(b) and 2, the rear-side spring member 11 has a plate shape in its natural state before assembly, and is overall constituted of an outer circumferential side portion 11a forming a planar view rectangular toroid, an inner circumferential side portion 11b which has a planar view arc shape, and is disposed at the inner circumference of the outer circumferential side portion 11a, and four arm portions 11c linking the outer circumferential portion 11a and the inner circumferential portion 11b ; and can be freely deformed in the Z direction and in the X-Y direction.

The rear-side spring member 11 is configured from the four springs of a rear-side first spring 40, rear-side second spring 41, rear-side third spring 42, and rear-side fourth spring 43, and each of the four rear-side springs 40 to 43 is made in substantially the same shape so that the rear-side spring member 11 is separated into four even parts. The rear-side first spring 40 to rear-side fourth spring 43 each have an outer circumferential side portion 11a, inner circumferential side portion lib and arm portion 11c.

One end of the one side coil 16 is connected to the inner circumferential side portion 11b of the rear-side first spring 40, and the other end of the one side coil 16 is connected to the inner circumferential side portion 11b of the rear-side third spring 42. The outer circumferential side portion 11a of the rear-side first spring 40 is connected to a first current terminal 33a of the X-Y driving portion 33, and the outer circumferential side portion 11a of the rear-side third spring 42 is connected to the second current terminal 33b of the X-Y driving portion 33.

One end of the other side coil 18 is connected to the inner circumferential side portion 11b of the rear-side second spring 41, and the other end of the other side coil 18 is connected to the inner circumferential side portion 11b of the rear-side fourth spring 43. The outer circumferential side portion 11a of the rear-side second spring 42 is connected to a third current terminal 33c of the X-Y driving portion 33, and the outer circumferential side portion 11a of the rear-side fourth spring 43 is connected to a fourth current terminal 33d of the X-Y driving portion 33. In the present embodiment, the first current terminal 33a and the third current terminal 33c of the X-Y driving portions 33 are plus electrodes, and the second current terminal 33b and the fourth current terminal 33d are minus electrodes; however, if they are terminals flowing direct current to each of the coils 16 and 18, there is no limitation for any of the current terminals being minus or plus.

It should be noted that each of the outer circumferential side portions 11a of the rear-side spring member 11 is placed on the base 8 and kept by the yoke 3 through the rear-side spacer 15. In addition, each inner circumferential side portion 11b is fixed to a back end of the lens support 5.

The lens support 5 is supported so as to be freely moveable in the optical axis direction (Z direction) and X-Y direction by the front-side spring member 9 and the rear-side spring member 11.

Thus, by making an electric current flow in the first coil 19, the lens support 5 moves in the optical axis direction front direction, and the lens support 5 stops at a position where the resultant force in the front-rear direction of the energizing force of the front side spring member 9 and the rear side spring member 11 and the electromagnetic force generated between the first coil 19 and the magnet 17 are balanced.

In the case of moving the lens support 5 in the X-Y direction, it stops at a position where, by making electric currents of predetermined values respectively flow in the one second coil 16a or the other second coil 18, or alternatively in the one second coil 16 and the other second coil 18, the resultant force of the springs in the X-Y direction of the front-side spring member 9 and the rear-side spring member 11, and the electromagnetic force generated between the one second coil 16 and other second coil 18 and each of the opposing magnets 17 are balanced.

Next, the assembly, operation and effects of the lens driving device 1 according to the embodiments of the present invention are explained. Before the assembly of the lens driving device 1, the coil member 4 is formed by adhering and fixing each of the second coils 16a, 16b, 18a and 18b to the outer circumferential face of the first coil 19, and this is fixed to the outer circumference of the lens support 5, as shown in FIG. 2. It should be noted that the one second coil portions 16a and 16b are connected in series, and the other second coil portions 18a and 18b are also connected in series.

In the assembly of the lens driving device 1, as shown in FIG. 2, the rear-side spring member 11, the rear side spacer 15, the lens support 5 with the coil member 4 fixed to its outer circumference, the yoke 3 with each of the magnets 17 fixed to the corner 15 of the its outer circumferential side wall 3a, the front side spacer 6, the front-side spring member 9 and the frame 7, are fixed to the base 8 in sequence.

The assembly of the lens support 5 with the coil member 4 fixed thereto, and the yoke 3 with the magnets 17 fixed to its inner circumferential face is carried out by inserting the lens support 5 into the inner circumference of the yoke 3 from its rear side towards its front side.

As shown in FIG. 1, one coil wire end of the first coil 19 is connected to the inner circumferential side portion 9b of the front-side second spring 20, and the other coil wire end thereof is connected to the inner circumferential side portion 9b of the front-side second spring 21.

One coil wire end of the one second coil 16 is connected to the inner circumferential side portion 11b of the rear-side first spring member 40, and the other coil wire end thereof is connected to the inner circumferential side portion 11b of the rear-side third spring member 42.

One coil wire end of the other second coil 18 is connected to the inner circumferential side portion 11b of the rear-side second spring member 41, and the other coil wire end thereof is connected to the inner circumferential side portion 11b of the rear-side fourth spring member 43.

Each connection is done with solder, for example.

It should be noted that the outer circumferential side portion 9a of the front-side first spring 20 connects to the plus side current terminal 32a of the Z driving portion 32, and the outer circumferential side portion 9a of the front-side second spring 21 connects to the minus side current terminal 32b of the Z driving portion 32.

The outer circumferential side portion 11a of the rear-side first spring 40 is connected to the first current terminal 33a of the X-Y driving portion 33, and the outer circumferential side portion 11a of the rear-side third spring 42 connects to the second current terminal 33b of the X-Y driving portion 33. In the same way, the outer circumferential side portion 11a of the rear-side second spring 41 is connected to the third current terminal 33c of the X-Y driving portion 33, and the outer circumferential side portion 11a of the rear-side fourth spring 43 is connected to the fourth current terminal 33d of the X-Y driving portion 33.

In the driving of the lens driving device 1 according to the present embodiment in the Z direction, in FIG. 5, the Z driving portion 32, while comparing the peaks of the high frequency components (contrast) received from the image sensor 31, causes the lens support 5 to move in a straight line in the Z direction towards the focus position.

When the lens support 5 is moved in a straight line in the Z direction, the lens support 5 stops at a position where the electromagnetic force generated with the magnet 17 which is generated by making an electrical current of an electric current value Z flow in the first coil 19, and the resultant force of the energizing forces of the front-side spring member 9 and the rear-side spring member 11 are balanced.

Further, in the X-Y control of the lens support 5 (image stabilization), the size of the hand shake amount in the X-Y direction from a gyro module or the like is received as a signal, the amount of image stabilization in the X direction and Y direction is calculated and the respective movement amounts E and F in the X-Y direction are determined, and current is passed through the one second coil 16, as well as the other second coil 18.

According to the present embodiment, the focusing movement of the lens support 5 is carried out by moving the lens support 5 in the optical axis direction by passing a current through the first coil 19, and image stabilization is carried out by moving the lens support 5 in the X-Y direction by passing an electric current of a predetermined value through selected second coils 16 and 18. In this way, it is possible to carry out the focusing movement and the image stabilization movement of the lens support 5.

The front-side spring member 9 is configured by the two springs of the front-side first spring 20 and the front-side second spring 21, the rear-side spring member 11 is configured by the rear-side first spring 40, rear-side second spring 41, rear-side third spring 42 and rear-side fourth spring 43, with a total of six springs, and the total of six coil wire ends of the one and other coil wire ends of the first coil 19, the one and the other coil wire ends of the one second coil 16, and the one and the other coil wire ends of the other second coil 18 are connected to different springs; therefore, the coil wires of each coil can be arranged without drawing to outside of the lens driving device, whereby the configuration is simply and manufacture thereof is facilitated.

Since each coil wire end of the first coil 19, the one second coil 16 and the other second coil 18 are not drawn to outside of the lens driving device 1, it is possible to prevent the coil wires from hindering the movement of the lens support.

The front-side first spring 20 and front side second spring 21 configuring the front-side spring member 9, and the rear-side first to fourth springs 40 to 43 configuring the rear-side spring member 11 are each disposed to be flush in the circumferential direction of the lens support 5; therefore, it is possible to prevent the dimension in the optical axis direction from becoming large.

In addition, since the arm portions 9c and the arm portions 11c of each spring 20, 21 and 40 to 43, respectively, make a configuration having a bent portion that is bent in the circumferential direction, the space of each of the arm portions 9c and 11c can be reduced, and each of the six springs 20, 21 and 40 to 43 can be made compact in a small size and.

The one second coil 16 and the other second coil 18 are configured by the two coil portions 16a, 16b and 18a, 18b, respectively, each of the four second coil portions 16a, 18a, 16b and 18b being provided at an even interval along the outer circumference of the lens support 5, and the two second coil portions 16a, 18a and 16b, 18b facing each other being connected in series, respective; therefore, the driving force in the X-Y direction can be raised without increasing the number of springs connecting the coil wire ends of each coil.

The magnets 17 concurrently serve for the focusing movement and for the image stabilization movement, and it is possible to move the lens support 5 in the optical axis direction and in the X-Y direction with the one first coil 19, the two second coils 16 and 18, and the four magnets 17. Therefore, it is possible to carry out focusing movement and image stabilization movement of the lens support 5 with a simple constitution and a small number of parts.

The present invention is not limited to the above-described embodiments, and many modifications are possible within a scope that does not deviate from the gist of the present invention.

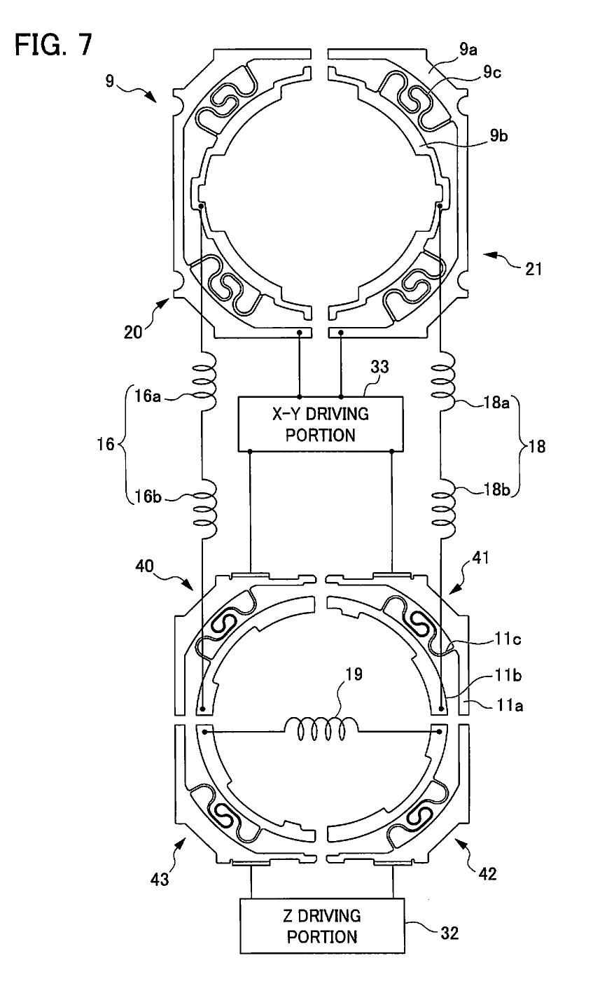

For example, as shown in FIG. 7, so long as being a configuration in which leading ends of the one second coil 16 and the other second coil 18 are connected to a total of the four springs of the two front-side springs 20 and 21 and the two rear-side springs 40 and 41, and the coil wire ends of the first coil 19 are connected to the two rear-side springs 42 and 43, it is possible to arbitrarily set to which spring the respective coil leading ends of the first coil 19, the one second coil 16 and the other second coil 18 are connected.

In addition, although in the aforementioned embodiment, the front-side spring member 9 is configured by the two front-side springs 20 and 21, the rear-side spring member 11 is configured by the four rear-side springs 40 to 43 to make a total of six springs, it may also be a configuration in which the front-side spring member 9 is configured by three front-side springs and the rear-side spring member is configured by three rear-side springs, or the front-side spring member 9 is configured by four front-side springs, the rear-side spring member is configured by two rear-side springs, the two coil wire ends of the first coil 19, the two coil wire ends of the one second coil 16, and the two coil wire ends of the other second coil 18 are connected to any different springs.

So long as the front-side spring member 9 and the rear-side spring member 11 assume an external shape that is substantially circular, the external shape is not limited.

It is not necessarily limited to the one second coil 16 being configured by the two coil portions 16a and 16b, and the other second coil 18 being configured by the two coil portions 18a and 18b, and the one and the other second coils 16 and 18 may be provided with only one coil portion, for a total of two coil portions being provided at 90 degree intervals from each other.

The one and the other second coil portions 16a, 16b, 18a and 18b may be arranged on the inner circumferential side of the first coil 19.

The one and the other second coil portions 16a, 16b, 18a and 18b may be made a configuration in which the lens support 5 is moved in the X direction by arranging the one second coil portions 16a and 16b connected in series in the X direction, and flowing current through the one second coil portions 16a and 16b, and the lens support is moved in the Y direction by arranging the other second coil portions 18a and 18b connected in series in the Y direction and flowing current through the other second coil portions 18a and 18b.

Although four of the magnets 17 are arranged at the four corners of the yoke 3, it is not limited to this, and one magnet 17 of toroidal form may be provided facing the outer circumferential face of the first coil 19, with one among the inner circumferential side and the outer circumferential side thereof being established as the N pole, and the other as the S pole.

The second coils 16 and 18 may each be a ring shape in a plan view, and the magnets may oppose area portions along the circumferential direction of the lens support 5.

The yoke 3 may include an inner circumferential side wall provided to stand from the inner circumferential side end of the radial wall 3b to the rear side and to be parallel with the outer circumferential side wall 3a, a gap may be provided between the first coil 19 and the lens support 5, and the inner circumferential side wall may be disposed in this gap.

The lens driving device 1 may also have a zoom function by being equipped with a zoom lens.

What is claimed is:

1. A lens driving device comprising:
a lens support for supporting a lens in an inner circumference thereof;
a fixed member provided at an outer circumferential side of the lens support;
a first spring member provided at one side of the lens support in an optical axis direction and supporting the lens support to be freely movable by mounting one end thereof to the fixed member, and mounting another end thereof to the lens support;
a second spring member provided at another side of the lens support in the optical axis direction and supporting the lens support to be freely movable by mounting one end thereof to the fixed member and mounting another end thereof to the lens support;
a first coil wound in a circumferential direction around the outer circumference of the lens support;
two second coils disposed with a 90 degree interval in the circumferential direction at the outer circumference of the lens support; and
a magnet provided at the fixed member, and provided to face an outer circumferential face of the first coil, the magnet being opposite the second coil at a position at which the second coil is provided,
wherein the first spring member and the second spring member are configured by a plurality of springs separated from each other, collectively having a total of six springs, each coil wire end of the first coil and the two of the second coils being connected to a different spring to allow an electric current to flow from the spring to each of the coils, respectively, and when moving the lens support in the optical axis direction, electric current is flowed through the first coil, and when moving the lens support in an X-Y direction that is orthogonal to the optical axis, a predetermined electric current is flowed through a predetermined one of the second coils.

2. The lens driving device according to claim 1, wherein each of the second coils includes two coils portions connected in series, each of the coil portions being provided at even an interval along the outer circumference of the lens support, and one of the second coils disposing the two coil portions at positions opposing each other.

3. An autofocus camera, comprising:
the lens driving device according to claim 1; and
an imaging sensor provided at an image forming side of the lens of the lens support.

4. An autofocus camera, comprising:
the lens driving device according to claim 2; and
an image sensor provided at an image forming side of the lens of the lens support.

5. A camera-equipped mobile terminal comprising the autofocus camera according to claim 3.

6. A camera-equipped mobile terminal comprising the autofocus camera according to claim 4.
